(19) United States
(12) Patent Application Publication
(10) Pub. No.: US 2010/0121559 A1
(43) Pub. Date: May 13, 2010

(54) Water Based Systems for Direct Injection Knock Prevention in Spark Ignition Engines

(76) Inventors: Leslie Bromberg, Sharon, MA (US); Daniel R. Cohn, Cambridge, MA (US); John Heywood, Newtonville, MA (US)

Correspondence Address: Nields, Lemack & Frame, LLC, 176 E. Main Street, Suite #5, Westborough, MA, 01581, US

(21) Appl. No.: 12/610,403

(22) Filed: Nov. 2, 2009

Related U.S. Application Data
(60) Provisional application No. 61/111,131, filed on Nov. 4, 2008.
(60) Provisional application No. 61/116,778, filed on Nov. 21, 2008.

(51) Int. Cl. F02D 41/30; B01D 17/12; B01D 11/04; B01D 17/038; B01D 17/02; B01D 63/00; F02M 7/00; F02B 47/02

(52) U.S. Cl. 701/111; 210/195.1; 422/256; 210/153; 210/195.2; 210/143; 210/149; 210/96.1; 210/97; 123/436; 123/25 A

(57) ABSTRACT

A fuel management system for using water for on-board vehicular separation of ethanol from ethanol-gasoline blends is described. Water or a water-alcohol mixture from a secondary tank is mixed with the ethanol-gasoline blend resulting in separation of the ethanol. By using on-board vehicular separation, the consumption of the externally supplied liquid from a secondary tank can be decreased to less than 1% of the gasoline consumption. This allows for long refilling periods for the externally supplied fluid. In another embodiment, a water-based fluid is directly injected into the cylinders of a spark ignition engine to eliminate knocking without causing misfire. In a further embodiment, an alcohol-based fluid is also used in those circumstances where injection of the water-based fluid may cause misfire.

This application claims priority of U.S. Provisional Patent Application Ser. No. 61/111,131, filed Nov. 4, 2008 and U.S. Provisional Patent Application Ser. No. 61/116,778, filed Nov. 21, 2008, the disclosures of which are herein incorporated by reference in their entireties.

### BACKGROUND OF THE INVENTION

Increasing concerns about global climate change and energy security call for cost effective new approaches to reduce use of fossil fuels in cars and other vehicles. Recent domestic legislation, as well as the Kyoto protocol for greenhouse gas reduction, set challenging goals for reduction of CO₂ emissions. For example, the California legislation phases in requirements for reducing CO₂ generation by 30% by 2015. Other states may follow California in establishing lower emission goals. While new technologies, such as electric vehicles, are being pursued, cost effective approaches using currently available technology are needed to achieve the widespread use necessary to meet these aggressive goals for reduced fossil fuel consumption. Ethanol biofuel could play an important role in meeting these goals by enabling a substantial increase in the efficiency of gasoline engines.

One method of improving the efficiency of traditional spark ignition gasoline engines and diesel engine is through the use of high compression ratio operation, particularly in conjunction with smaller sized engines. The aggressive turbocharging (or supercharging) of the engine provides increased boosting of naturally aspirated cylinder pressure. This pressure boosting allows a strongly turbocharged engine to match the maximum torque and power capability of a much larger engine. Thus, the engine may produce increased torque and power when needed. This downsized engine advantageously has higher fuel efficiency due to its low friction, especially at the loads used in typical urban driving.

Engine efficiency can also be increased by use of higher compression ratio. Compression ratio is defined as the ratio of the volume of the cylinder when the piston is at the bottom of its stroke, as compared to its volume at the top of its stroke. Like turbocharging, this technique serves to further increase the pressure of the gasoline/air mixture at the time of combustion.

However, the use of these techniques in spark ignited engines is limited by the problem of engine knock. Knock is the undesired rapid gasoline energy release due to autoignition of the end gas, and can damage the engine. Knock most often occurs at high values of torque, when the pressure and temperature of the gasoline/air mixture exceed certain levels. At these high temperature and pressure levels, the gasoline/air mixture becomes unstable, and therefore may combust in the absence of a spark.

Octane number represents the resistance of a fuel to autoignition. Thus, high octane gasoline (for example, 93 octane number vs. 87 octane number for regular gasoline) may be used to prevent knock and allow operation at higher maximum values of torque and power. Additionally, other changes to engine operation, such as modified valve timing may also help. However, these changes alone are insufficient to fully realize the benefits of turbocharging and higher compression ratio.

The use of higher octane fuels can reduce the problem of knocking. For example, ethanol is commonly added to gasoline. Ethanol has a blending octane number of roughly 110, and is attractive since it is a renewable energy source that can be obtained using biomass. Many gasoline mixtures currently available are about 10% ethanol by volume. However, this introduction of ethanol does little to affect the overall octane of the mixture. Mixtures containing higher percentages of ethanol, such as E85, suffer from other drawbacks. Specifically, ethanol is more expensive than gasoline, and is much more limited in its supply. Thus, it is unlikely that ethanol alone will replace gasoline as the fuel for automobiles and other vehicles. Other fuels, such as methanol, also have a higher blending octane number, such as 130, but suffer from the same drawbacks listed above.

Direct injection of an anti-knock fluid having alcohol content (such as ethanol or methanol) into the cylinder suppresses knock. In some embodiments, the anti-knock fluid may also include gasoline and/or water. FIG. 10 shows a representative boost system. This boost system can be incorporated into any vehicle with a spark ignition engine, including cars, SUVs and trucks.

The boost system 10 includes a spark ignition engine 17, in communication with a manifold 11. The manifold 11 receives compressed air from turbocharger or supercharger 12, and gasoline from gasoline tank 13. The gasoline and air are mixed in the manifold 11, and enter the engine 17, such as through port fuel injection. A second tank 14 is used to hold anti-knock fluid, which preferably enters the engine 17 through direct injection. Additionally, the boost system 10 may include a knock sensor 15, adapted to monitor the onset of knock. The system also includes a boost system controller 16. The boost system controller receives an input from the knock sensor 15, and based on this input, controls the release of anti-knock fluid from the second tank 14 and the release of gasoline from the gasoline tank 13. In some embodiments, the boost system controller 16 utilizes open loop control to determine the amount of gasoline and anti-knock fluid to inject into the engine 17. In another embodiment, a closed loop algorithm is used to determine the amount of anti-knock fluid, based on the knock sensor 15, and such parameters as RPM and torque.

Ethanol has a high fuel octane number (a blending octane number of 110). Moreover, appropriate direct injection of ethanol, or other alcohol-containing anti-knock fluids, can provide an even larger additional knock suppression effect due to the substantial air charge cooling resulting from its high heat of vaporization. Calculations indicate that by increasing the fraction of the fuel provided by ethanol up to 100 percent when needed at high values of torque, an engine could operate without knock at more than twice the torque and power levels that would otherwise be possible. The level of knock suppression can be greater than that of fuel with an octane rating of 130 octane numbers injected into the engine intake. The large increase in knock resistance and allowed inlet manifold pressure can make possible a factor of 2 decrease in engine size (e.g. a 4 cylinder engine instead of an 8 cylinder engine) along with a significant increase in compression ratio (for example, from 10 to 12). This type of operation could provide an increase in efficiency of 30% or more. The combination of direct injection and a turbocharger with appropriate low rpm response provide the desired response capability.

Because of the limited supply of ethanol relative to gasoline and its higher cost, and to minimize the inconvenience to the operator of refueling a second fluid, it is desirable to minimize the amount of ethanol, or anti-knock fluid, that is required to meet the knock resistance requirement. By use of an optimized fuel management system, the required ethanol energy consumption over a drive cycle can be kept to less than 10% of the gasoline energy consumption. This low ratio of ethanol to gasoline consumption is achieved by using the direct ethanol injection only during those times where the engine is experiencing high values of torque where knock suppression is required and by minimizing the ethanol/gasoline ratio at each point in the drive cycle. During the large fraction of the drive cycle where the torque and power are low, the engine would use only gasoline introduced into the engine by conventional port fueling. When knock suppression is needed at high torque, the fraction of directly injected ethanol is increased with increasing torque. In this way, the knock suppression benefit of a given amount of ethanol is optimized.

In one embodiment, an anti-knock fluid, such as an alcohol (such as ethanol or methanol) or alcohol blend with water and/or gasoline, is kept in a container separate from the main gasoline tank. As shown in FIG. 10, anti-knock fluid from a small separate fuel tank is directly injected into the cylinders (in contrast to conventional port injection of gasoline into the manifold). The concept uses the direct fuel injector technology that is now being employed in production gasoline engine vehicles. The traditional path used by the gasoline is maintained, and is used to aspirate the gasoline prior to its injection into the cylinder. In situations where knocking may occur, such as high torque or towing, the anti-knock fluid is injected directly into the cylinder. The high heat of vaporization of the boost gas reduces the temperature of the gasoline/air mixture, thereby increasing its stability. In situations where knocking is not common, such as normal highway driving, the anti-knock fluid is not used. Thus, by limiting the use of the anti-knock fluid to only those situations where knocking is prevalent, the amount of anti-knock fluid used can be minimized.

By directly injecting the anti-knock fluid into the cylinder, knocking can be significantly reduced. This allows boost ratios of 2 to 3 and compression ratios in the 11 to 14 range. A fuel efficiency increase of 20%-30% relative to port fuel injected engines can be achieved using these parameters. Alcohol boosting can provide a means to obtain rapid penetration of high efficiency engine technology in cars and light duty trucks.

The flexibility of using two fuels for spark ignition engines has been described in U.S. Pat. No. 7,314,033 and U.S. Pat. No. 7,225,787, the disclosures of which are herein incorporated by reference in their entireties. By using a conventional fuel, such as reformulated gasoline in combination with a second fuel (or anti-knock fluid) that has high octane and high heat of vaporization that is provided from a separate tank, it is possible to prevent the occurrence of knock in spark ignition (SI) engines. The second fuel is used on-demand to prevent knock at high torque. Elimination of knock enables engine modification that can yield substantial improvement in fuel efficiency, at comparable performance, or at much higher power at constant fuel efficiency.

It would be beneficial if water and other polar fluids could be used to perform the separation of ethanol from reformulated gasoline. It would also be beneficial if the separated water-alcohol mixture could be used as a second fuel or an anti-knock agent in an engine system. In another embodiment, it would be beneficial if the second fuel could be externally supplied at such a frequency so as not to inconvenience the operator. In a further embodiment, it would be beneficial if the externally supplied fuel could be water.

### SUMMARY OF THE INVENTION

A system and method for separating alcohol from reformulated gasoline and storing the separated fluid onboard the vehicle is disclosed. Fluid from a second tank is used to separate ethanol from the reformulated gasoline in the primary tank. In some embodiments, the separated water-alcohol mixture is kept in a separate tank and is used as an anti-knock agent, which is directly injected into the cylinder. In another embodiment, water or a weak water-alcohol mixture is used as the anti-knock agent. High water content makes possible the occurrence of misfiring. Systems and methods for using water as an anti-knock fluid, while minimizing or eliminating misfiring are also disclosed.

### BRIEF DESCRIPTION OF THE DRAWINGS

FIG. 1a is a chart showing ethanol concentration in the aqueous phase for two reformulated gasoline blends (E10 and E20) and for two ambient temperatures (283° K, 313° K).

FIG. 1b is a chart showing the fraction of extracted ethanol as a function of the ethanol fraction in the aqueous phase (by mass).

FIG. 2 is a chart showing water requirement (as fraction of the gasoline utilization) at borderline knock throughout the engine map.

FIG. 3 is a chart showing the ethanol fraction (by energy) across the engine map, for similar engine conditions as those of FIG. 2 for DI water injection.

FIG. 4 is a chart showing the ratio (by volume) of the directly injected knock suppressing fluid to gasoline needed for knock prevention, as a function of the ethanol fraction (by mass) in this fluid, where the engine operates at 2 bar manifold pressure and has port fuel injection of gasoline.

FIG. 5 is a chart showing the external additive fractional requirements (by volume relative to gasoline) for operation at high torque, low speed operation, as a function of the ethanol content (by mass) of the secondary fluid.

FIG. 6 is a schematic diagram of system with 3 tanks, and a separation unit, where Tank 1 contains a gasoline-alcohol blend, Tank 2 contains water and Tank 3 contains a water-alcohol mixture that includes the alcohol that is separated from the gasoline.

FIG. 7 is a schematic diagram of a fuel management system for using either fluid from the second tank or third tank for on-demand knock suppression including the use of a misfire sensor.

FIG. 8 is a schematic diagram of a system where the ethanol/gasoline separation occurs directly in the gasoline tank, and the aqueous phase is removed and stored in a mixture tank.

FIG. 9 is a schematic diagram of a system that eliminates the mixture tank.

FIG. 10 is a schematic diagram of a boost system, using direct injection.

FIG. 11 is a schematic diagram of a boost system, using a water-based anti-knock fluid.

FIG. 12 is a schematic diagram of a second embodiment of a boost system using a water-based anti-knock fluid.

FIG. 13 is a graph showing the relationship between water concentration and manifold pressure in a spark ignition engine.

### DETAILED DESCRIPTION OF THE INVENTION

The equilibrium between water, ethanol and hydrocarbon fuels, modeled as PRF (Primary Reference Fuels, mixtures of iso-octane and n-heptane) has been explored. The equilibrium in the aqueous phase has been measured, or can be derived from the measurements on the organic phase.

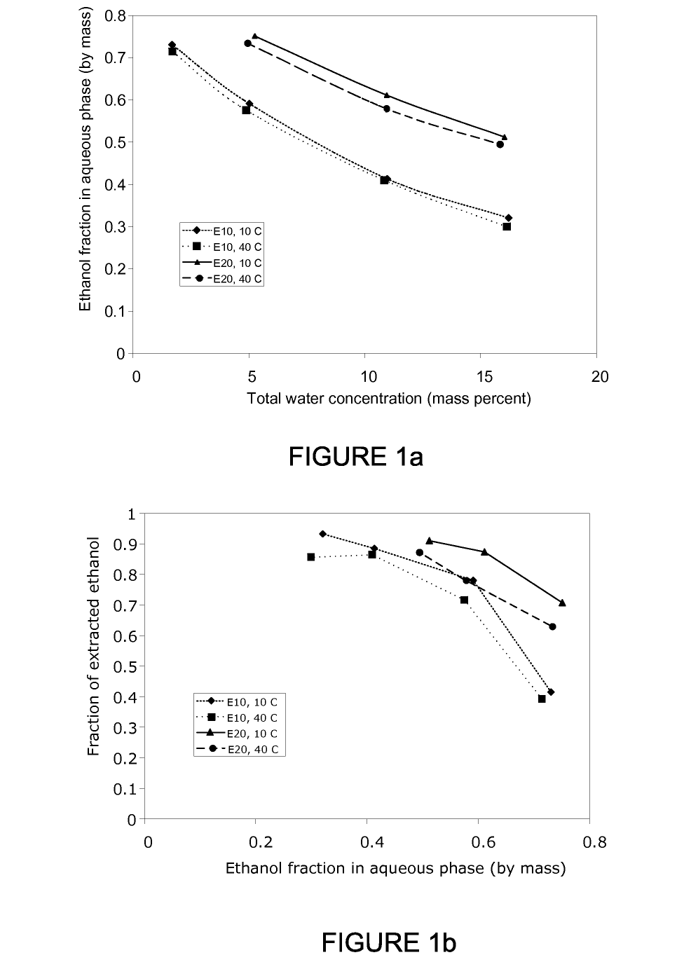

It is possible to determine the concentration of ethanol (or methanol) in the aqueous phase (the liquid phase with substantial water content) when water is mixed with a gasoline-ethanol blend. FIG. 1a shows the results, as a function of the water mass fraction in the overall mixture (the water fraction represents the amount of water divided by the total amount of water, alcohol and gasoline). The results are shown for two reformulated gasoline blends (E10 and E20), and for two temperatures (10° C. and 40° C.).

As seen in FIG. 1a, the ratio of ethanol to water increases with decreasing water concentration levels in the mixture. For overall water concentrations on the order of 5% (water to fuel, with fuel being E10 or E20), the concentration can be as high as 75%, that is, it is 3:1 ethanol/water ratio.

As the temperature increases, the ability of water to extract ethanol from the organic phase decreases, as the blending characteristics of the ethanol/gasoline increases.

FIG. 1a shows that, at the very low concentration of water in the mixture, the composition of the aqueous phase is determined from what is missing in the organic phase, as it was not possible to remove the aqueous phase without a substantial amount of hydrocarbons. There is substantial noise, especially at the lowest concentrations, as shown in FIG. 1 for E20 at 40° C.

From the equilibrium, it is expected that as the amount of water in the system increases, the amount of ethanol that is retrieved into the aqueous phase from the organic phase increases, but does not increase as fast as the amount of water. It is observed that the ethanol concentration levels in the aqueous phase decreases with increasing water content, and the total amount of extracted ethanol, increases. The trade-off is shown in FIG. 1b. It is likely that removal of more than 50% of the ethanol from the hydrocarbons is possible with systems that yield ethanol concentration (by mass) in the aqueous phase of more than 65%.

Equilibrium systems that contain methanol are more complex than with ethanol/water, as methanol can dissolve hydrocarbons in large amounts, in particular, paraffinic hydrocarbons. Thus, there are substantial amounts of organic phase together with the methanol. Compared to neat ethanol, the volume requirements at borderline knock for methanol are about ⅓ lower than ethanol. Water addition to methanol, as the case with ethanol, can substantially decrease the required amount of the antiknock fluid.

It is also possible to use water as an anti-knock agent. The impact of injecting water (direct injection) is calculated using the model developed by Bromberg. The model followed the conditions (adiabatic) of the unburnt air-fuel mixture in the cylinder during the engine revolution. Autoignition is defined as the situation when the unburnt air-fuel mixture autoignites. A simple model has been used to determine the effect of the compression (from the turbocharging and/or supercharging) on the air temperature, as well as the effect of intercooling.

A chemical kinetics model is used to calculate the compression of the end gas, which is driven both by the motion of the cylinder as well as the combustion of the air/fuel mixture. The model follows the compression and part of the expansion process.

For the calculations presented herein, it has been assumed that the compression ratio of the engine is 10, although other values are within the scope of the invention. It is assumed that the water evaporates soon after Inlet Valve Closing (IVC), so that conditions similar to constant-volume during evaporation are used. The charge cooling effect on the temperature and pressure is maximized in this manner.

In calculating the charge cooling, only the heat of vaporization is used. The enthalpy to raise the temperature from the injection temperature to the boiling temperature of the fluid has been neglected. It is assumed that the water is injected, as a liquid, directly into the cylinder to cool the in-cylinder charge instead of the wall of the inlet port or the valves.

The model is used to determine the requirement at 1000 RPM as a function of inlet manifold pressure. The model is also used to determine the requirements at 2 bar manifold pressure for different engine speed (from 1000 RPM to 4000 RPM), and the maximum inlet manifold pressure that does not result in knock (without addition of water). It should be noted that effects of Exhaust Gas Recirculation (EGR), chemistry due to the internal residuals, and spark retard at conditions of heavy load have not been included in this analysis. It is possible to decrease the fluid requirements at conditions of high load, by the use of EGR (especially cooled EGR) and spark retard. The water requirement is then interpolated through the engine map.

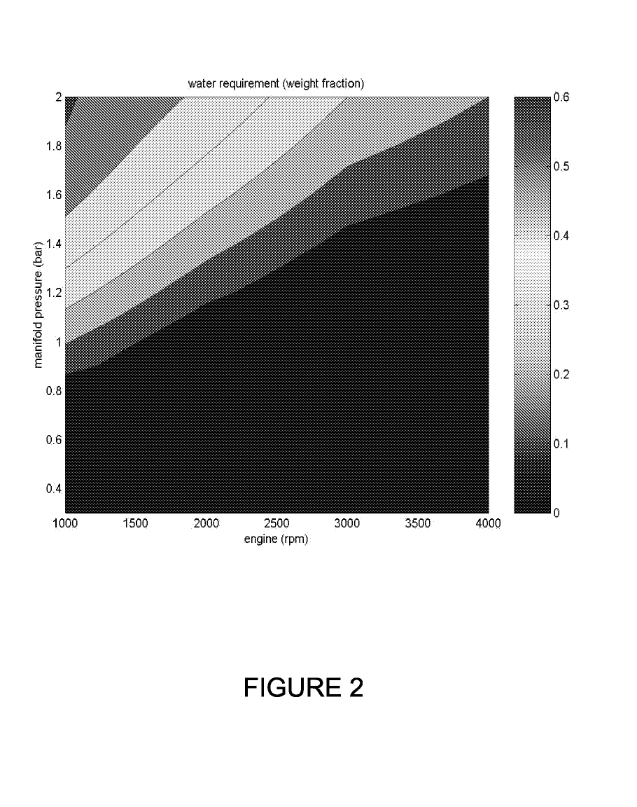

The results are shown in FIG. 2. The figure shows the water fraction (by volume) requirement at conditions of borderline knock. Since water is about 20% more dense than gasoline, the fraction volume requirements would be approximately 0.8 those shown in FIG. 2. Note that at low RPM, the requirement for anti-knock fluid is much greater than at higher RPM. For example, an engine requires no water to operate at 1.6 bar and 4000 RPM, but requires nearly 50% water (by weight) at 1.6 bar and 1000 RPM. At the maximum requirement, at 2 bar and 1000 RPM, the water fraction requirement is about 55% (by volume).

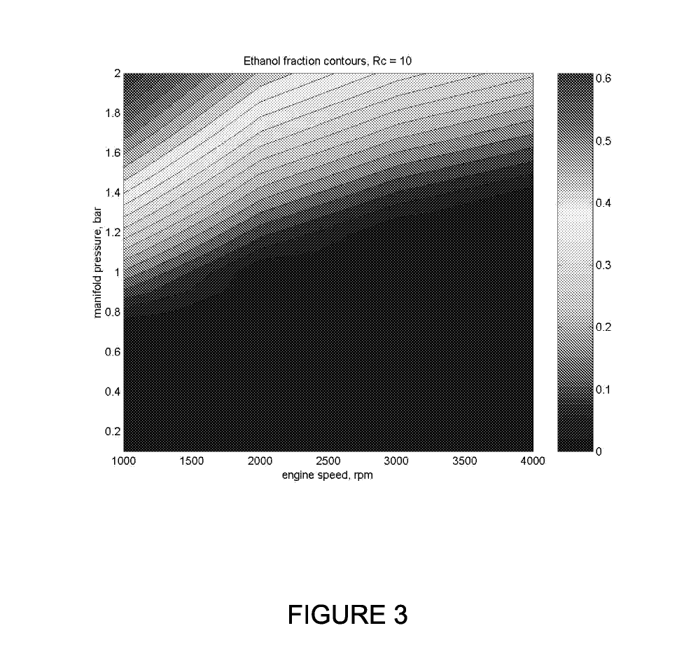

As a comparison, FIG. 3 shows the results for direct injected (DI) ethanol, with port fuel injected (PFI) gasoline, for a compression ratio of 10, which represent the same conditions used above for water.

It should be noted that the water fraction, in FIG. 2, refers to the ratio of water to gasoline. On the other hand, the ethanol fraction shown in FIG. 3 refers to the total energy fraction (energy in the ethanol over energy in the gasoline and the ethanol). At the lowest engine speed and the highest torque, the ethanol fraction by energy is 60%. Because ethanol has a lower heating value than gasoline (27 MJ/kg vs. 43 MJ/kg for gasoline), and considering that ethanol has a slightly higher specific weight than gasoline, it is possible to calculate that the volume of ethanol required to prevent knock for those conditions is about 2 times greater than the volume of gasoline. In other words, one gallon of gasoline would require 2 gallons of ethanol at engine conditions of 1000 RPM and 2 bar. As shown in FIG. 2, the volume of water required to achieve the same is on the order of 50% of the volume of gasoline. In other words, one gallon of gasoline would require 0.5 gallon of water at engine conditions of 1000 RPM and 2 bar. Thus, the consumption of the second fluid is about 4 times smaller, if the second fluid is water instead of pure ethanol.

The calculations show that substantially less water is required for knock suppression at a given engine operation point than is the case when pure ethanol is used. However, there is a limit as to how much water can be used due to its adverse effect on flame speed. The use of large amounts of water adversely affecting combustion stability and create misfire. The amount of the water-based fluid that can be introduced into the engine without causing misfire can vary from location to location depending on the humidity level and other environmental variables of the air. A combustion stability/misfire detector can be useful providing information for adjusting the amount of water that is introduced into the engine as described later on in this disclosure.

Accordingly, there can be a need to employ alcohol as well as water either by addition to the water in the second tank or by extracting ethanol from gasoline or by using a combination of these two methods.

The requirements for the knock suppressing fluid can be calculated for ethanol-water mixtures with varying ethanol content and for methanol-water mixtures with varying methanol content. It is assumed that the heat of vaporization of the mixture is the same as the sums of the heat of vaporization of the components. Similarly, it is assumed that the volume of the mixture is the sum of the volumes of the components.

As the ethanol is being removed from the gasoline, the octane of the gasoline that remains in the tank is decreased. For a concentration of 2:1 ethanol/water ratio, it has been assumed that the remaining gasoline has an octane of 84, instead of 87 for the conditions where the ethanol is not withdrawn from the gasoline. Of course, the actual number will depend on the amount of ethanol that is withdrawn, and this in turn depends on the rate of utilization of the ethanol/water mixture in the engine to prevent knock.

The engine conditions analyzed below correspond to 1000 rpm, 2 bar manifold pressure. This condition, as shown in FIGS. 2 and 3, results in the largest requirement for the second fluid. Thus, other conditions would require less anti-knock fluid.

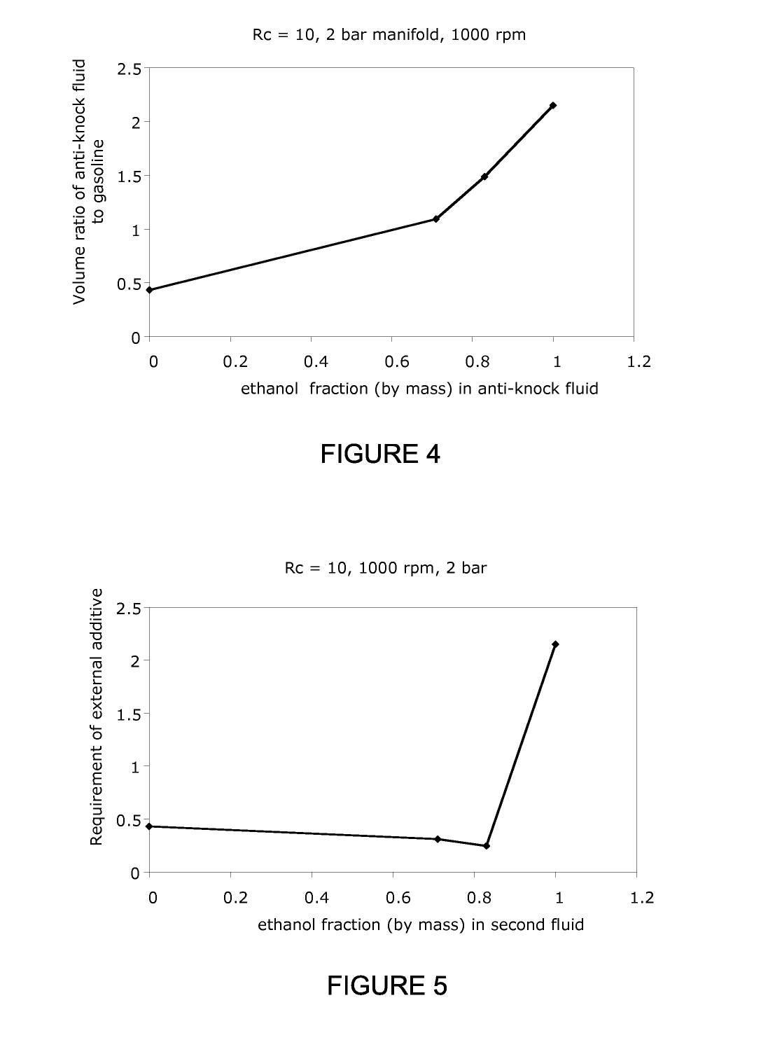

FIG. 4 shows the results of the volume fraction of the anti-knock fluid (i.e. the ethanol/water mixture) to that of the gasoline consumed. The gasoline being consumed includes the ethanol that has been removed from the gasoline, therefore this ratio refers to the volume of the anti-knock fluid (ethanol and water) divided by the volume of ethanol and gasoline. It is possible to have a separate tank that stores this fluid, or on-demand separation from the gasoline in the tank during operation.

The total volume requirement of the anti-knock fluid for knock resistance is the smallest for water and increases monotonically as the ethanol is added to the water. An ethanol fraction of 0.4 may, for example, represent that which would be needed to prevent freezing in very cold conditions and would be used in a windshield cleaner. At this value of the ethanol fraction, the required anti-knock fluid/gasoline ratio is about one third of that when the anti-knock fluid is pure ethanol (E100). That is, direct injection of this water-ethanol mixture is substantially more effective in preventing knock than the injection of pure ethanol. For the case of pure ethanol, (E100), the requirement at this operating point is about twice the rate of gasoline consumption. It should be pointed out that the engine rarely operates at this point. However, the noted trends are indicative of the implication of varying the ethanol concentration in the anti-knock fluid.

As noted above, an ethanol fraction of 0.4 may represent that which is needed to prevent freezing in very cold conditions. In some embodiments, an ethanol fraction of between 20% and 70% is used. This range guarantees operation in cold weather, while allowing lower anti-knock fluid consumption (as compared to pure ethanol).

FIG. 4 reflects the amount of the anti-knock fluid that is required for various fractions of ethanol in the antiknock fluid. However, in most cases, the supply of ethanol can be extracted from the gasoline, while the water must be supplied from another, typically external, source. Only in the case of very high percentages of ethanol must the ethanol be supplied by the operator, since the extracted fluid will have too great a percentage of water. However, in most cases, the water is provided from an external source. Thus, the required amount of water is typically of greater interest to the operator, since it is water that needs to be provided during periodic refueling of the secondary tank.

The actual requirements for the fluid that the consumer needs to add to the vehicle divided by the amount of gasoline consumed are shown in FIG. 5. As above, the curve of FIG. 5 is calculated for a condition (high torque, low RPM) that requires the greatest amount of knock suppression in a drive cycle. In the case of water as the fluid that is added by the driver, the amount of secondary fluid is augmented by the extraction of the ethanol from the gasoline.

In FIG. 5, when ethanol is the fluid that is provided directly to the secondary tank, the entire amount of ethanol that is used in providing knock suppression needs to be provided by the consumer. There is no on-board augmentation of the secondary fuel, and thus the amount is large. When only water is provided, substantially lower amounts are required, as described above, but as in the case of ethanol, there is no on-board augmentation of the water. However, between these two extremes, the water can be used to extract ethanol from the fuel, augmenting the amount of secondary fluid available. Thus, for all points on the graph (except 100% ethanol), FIG. 5 shows the requirement for externally added water. The 100% ethanol point shows the amount of ethanol that must be added.

It is advantageous to introduce the water in the smallest amount that can still be separated from the gasoline, in order to collect the maximum amount of ethanol from the gasoline. For the operating conditions shown in FIGS. 4 and 5, it is clear that the amount of water needed can be decreased by about a factor of 2 compared to the case with just water, due to the ethanol augmentation of the knock suppressing fluid. It should be noted that the conditions of FIGS. 4 and 5 are not possible for sustained operation of the engine, as the ethanol used in the mixture would exceed the total amount of ethanol available in the fuel. However, driving conditions are constantly changing. Therefore, the results shown in FIG. 5, concerning the reduction of the external fluid requirement due to on-board augmentation of the secondary fluid, should hold throughout the engine map.

Using E10, the maximum amount of ethanol that can be extracted in a steady state condition is about 5%. Based on this, the required amount of water to achieve this separation is less than about 1.5% (by volume) of the total gasoline consumption.

Having described the benefits of mixing water with ethanol as an anti-knock agent, and the ability to extract ethanol from reformulated gasoline, various implementations will now be described.

Most implementations have similar requirements. Typically, a first tank, also commonly referred to as a gas tank, is used to store reformulated gasoline. The reformulated gasoline is a blend of gasoline and an alcohol, such as ethanol or methanol, and is typically externally supplied, such as by the operator using a pumping system. A second tank is used to hold the separating fluid. This separating fluid is one that has the ability to separate the alcohol contained in the reformulated gasoline from the gasoline. In some embodiments, a polar fluid is used. More commonly, water or a water-based fluid is used as a separating fluid. In other embodiments, the water-based fluid is a water-alcohol mixture that is used as the separating fluid. The alcohol used in the mixture can be ethanol, methanol or isopropyl alcohol.

The reformulated gasoline and separating fluid are mixed in a separation region, where the separating fluid separates the alcohol in the reformulated gasoline from the gasoline. The separated alcohol is held in a separate volumetric space. In some embodiments, this space may be a separate tank, while in other embodiments, this space is a volume within one of the two previously described tanks. Throughout this specification, organic phase may be used to describe the gasoline or gasoline-alcohol blend. Aqueous phase is used to describe the water-alcohol mixture that has been separated from the gasoline. This separated fluid is also known as the anti-knock fluid and is injected into the cylinder of the vehicle.

In some embodiments, the separation region can be a discrete device, known as a separator unit. In other embodiments, the separation region may be integrated in one of the other tanks.

Typically, a system controller, containing a processing unit, instructions and associated memory and data, is used to control the operations of this fuel management system. The memory associated with this system controller contains the instructions executed by the controller. Using these instructions, this system controller can regulate the various aspects of the separation process, as described in more detail below.

The simplest and most straightforward implementation is through the use of 3 tanks. The first tank contains gasoline, blended with ethanol or methanol. The second tank contains a water-based fluid such as pure water (or water and an antifreeze agent such as ethanol or methanol). The third tank contains a fluid with a higher concentration of alcohol that is provided externally by the separation of the alcohol from the reformulated gasoline.

The fluid in the third tank is directly injected into the cylinders of a spark ignition engine when needed to prevent knock. Port injection of this fluid, while less effective, can also be employed.

The driver only needs to be concerned about refueling the first tank with gasoline, and refilling the water or water-alcohol mixtures in the second tank. Although it is possible to have access to the third tank for refueling, in principle and under normal circumstances, the third tank is invisible to the operator.

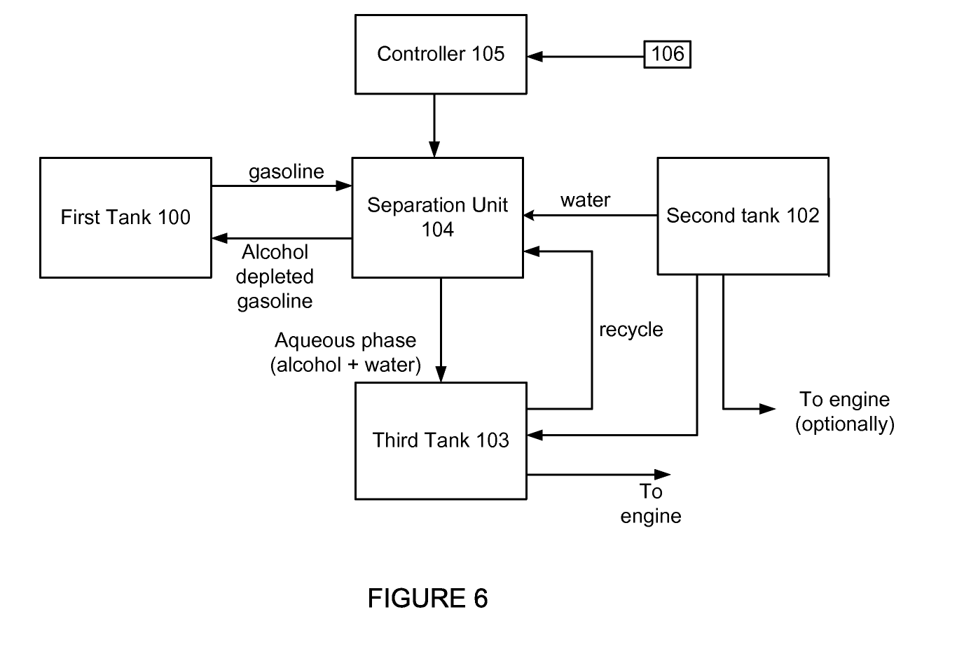

This system is illustrated in FIG. 6. First tank 100 contains the gasoline-alcohol mixture, such as delivered by conventional gasoline stations. Second tank 102 contains the externally supplied separating fluid, which is typically a water-based fluid (such as water or a water-alcohol mixture). Third tank 103 (the mixture tank) contains a fluid that includes the alcohol that is separated. This fluid is used for knock suppression by direct injection. The separation unit uses the properties of the water and the ethanol/gasoline blends in order to remove a substantial fraction of the ethanol from the gasoline. As shown in FIGS. 1 and 2, it is preferable to have small amounts of water in contact with a substantial amount of gasoline/ethanol blend in order to increase the concentration of ethanol in the resulting aqueous phase.

The separation process may be controlled by a system controller 105. Such a controller may determine when separation should occur and also determine whether separating fluid from the second tank 102 or recycled fluid from the third tank 103 should be used in the separation unit 104. The system controller 105 may have inputs from a temperature sensor 106. Additionally, sensors within the first tank 100, such as, but not limited to those capable of indicating ethanol concentration and overall fluid level, may also supply information to the controller 105. Similarly, a fluid level sensor may exist within the second tank 102 and provide input to the system controller 105. Finally, sensors can also exist within the third tank 103, such as, but not limited to those capable of indicating ethanol concentration and overall fluid level. The controller 105 may be used to control valves within the separation unit that determine the sources of fluids to be used and the periods during which separation is occurring.

The separation may be carried out by using the separation unit 104 as a batch separator, using only small amounts of water and maintaining it in the separation unit until the water and ethanol/gasoline blend reach equilibrium or are close to it, and then the aqueous phase (with the alcohol) is removed and more water is introduced into the system. The hydrocarbon content in the separation unit is exchanged in the process, in order to bring additional ethanol to the ethanol separating unit. The hydrocarbon fuel with ethanol can be introduced in the separator unit 104 a continuous fashion, or it can be introduced in a batch manner. As ethanol is removed from the first tank 100, the ethanol concentration of the gasoline decreases for each subsequent batch. Eventually, the concentration of ethanol in the gasoline-ethanol blend held in tank 100 may become low enough so as not to warrant further separation. In some embodiments, an indicator can be used to extend the separation process. This may be done based on an unmet demand for the knock suppressing fluid, which if left unaddressed, will result in comprised engine performance due to lack of second fluid.

It is also possible to recycle the aqueous phase from the mixture tank 103 to the separation unit 104. The purpose of doing this is to increase the concentration of ethanol in the secondary fluid stored in the mixture tank 103. The process can be repeated until either the mixture tank 103 is filled, or the ethanol concentration in the gasoline blend is such that the separating unit is already in equilibrium. Thus, further recycling the secondary fluid does not increase its concentration of ethanol. In some embodiments, recycling the aqueous phase may not be done.

In some embodiments, there may be external conditions where it would be advantageous to recycle the secondary fluid from the mixture tank 103 into the separation unit 104. One such external condition is a decrease in temperature. FIGS. 1 and 2 show that, for both fuels, a greater ethanol fraction is extracted at a given water concentration at lower temperatures. Therefore, it is possible to increase the concentration of ethanol in the aqueous phase if a subsequent separation is carried out at a lower temperature. Recycling the separated fluid when the system is at a lower temperature would increase the ethanol concentration. The separation process can be carried out even when the vehicle is not operating.

The separation unit 104 can employ membranes, physical or chemical separation. It could use gravity or centrifugal separation, or use hydrophilic membranes. The two fluids (water and gasoline blends) could be in contact with one another, or may be separated by a barrier. Those skilled in the art may be aware of other mechanisms can be used to separate the fluids and those are within the scope of the invention.

The separation of the ethanol from gasoline can be controlled so that it occurs under the temperature conditions that provide the most effective separation, such as at low temperatures. In one embodiment, the time at which the initial or recycled separation occurs is controlled by the signal from a temperature sensor 106. The temperature sensor 106 may emit a signal, indicating that separation can be done, or alternatively, can emit a signal indicative of the outside temperature. In this case, the system controller 105 may use the temperature information from the sensor to determine whether separation should be done.

In some embodiments, separation is performed between the first tank 100 and the second tank 102 during time periods that meet a first set of conditions or parameters. For example, the system controller 105 may use the concentration of ethanol in the first tank 100 to determine whether separation should proceed between the first tank 100 and second tank 102. Alternatively, conditions such as but not limited to the amount of liquid remaining in the first tank 100 and the second tank 102, and the ambient temperature may also be used. Additionally, separation may stop if the third tank 103 is filled to capacity.

A second set of conditions or parameters may be used to determine whether separation should occur between the first tank 100 and the mixture tank 103. These conditions may be the same as those described above, or may differ. For example, recycling may occur if there is a predetermined temperature decrease between the temperature at which the original separation was performed and the current temperature. The system controller may save information concerning the temperature at which the original separation was performed, and initiate a second separation, using the mixture tank, if there is a predetermined decreased in temperature. A recycling loop of the secondary fluid from the mixture tank 103 to the separation unit 104 is used to increase its ethanol concentration, as shown in FIG. 6.

The fuel tank-fueling system can be configured so that the separating fluid (water or water-alcohol mixture) in the second tank 102 can be used directly for direct injection knock suppression, as shown by the optional path to the engine in FIG. 6. Alternatively, the fluid in the second tank 102 can be sent to the separation unit 104 and used to separate out alcohol from gasoline to provide alcohol in high concentrations in the alcohol-water mixture in the third tank 103, which is then provided to the engine and used for knock suppression. In some embodiments, the fluid from the second tank 102 can be used for both purposes. In other embodiments, separating fluid from the second tank 102 can be transferred directly to the third tank 103, as shown in FIG. 6.

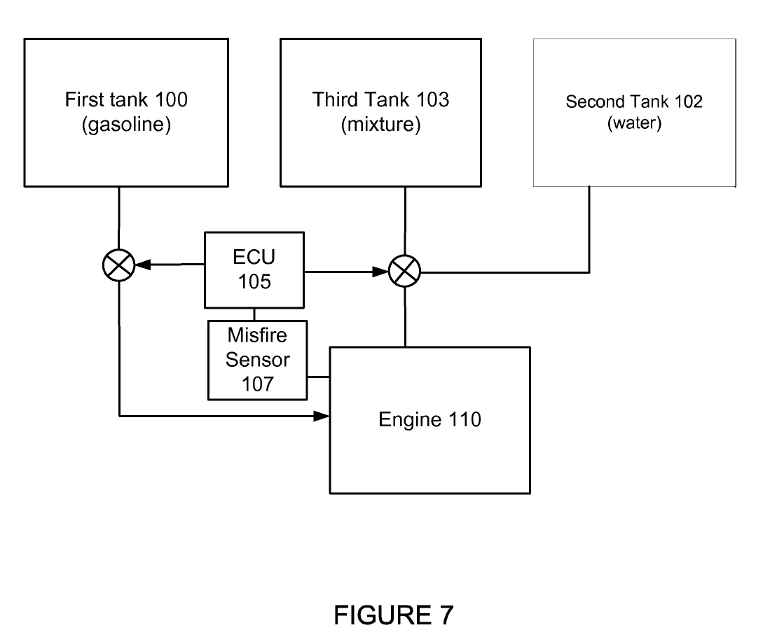

FIG. 7 shows an embodiment where either the fluid in the second tank (i.e. separating fluid) or the fluid in the third tank can be used for knock control. When water or water-alcohol mixtures with relatively low alcohol concentrations from the second tank 102 are used directly for knock suppression, the possibility of misfire exists. Therefore, in some embodiments, a combustion stability/misfire sensor 107 can be employed to limit the amount of water or water-alcohol mixture that is used in order to prevent misfire. The system controller, or Electronic Control Unit (ECU) 105 can receive an input from the misfire sensor 107, which allows it to determine the source for directly injected fluid. Below a certain ratio of the directly injected fluid from the second tank 102 to gasoline, the separating fluid may be used to prevent knock. However, above this ratio, the high ratio of water to gasoline causes misfiring, and therefore it is either necessary to limit the amount of turbocharging (to reduce the need for anti-knock fluid) and/or increase spark retard. Alternatively, the high alcohol concentration fluid from the third tank 103 can be employed. In some embodiments, it may be advantageous to use the fluid from the second tank 102 in certain conditions, and fluid from the mixture tank 103 in other conditions. For example, fluid from the second tank 102 can be used up to a certain manifold pressure and the fluid from the third tank 103 can be used above that manifold pressure. The system controller 105 may be used to determine the source of the directly injected fluid, using these parameters, or others. For example, the system controller 105 may also receive inputs concerning the fluid level in the second and third tanks and alter its selection of directly injected fluid based on this information. Other criteria can also be used as well.

In some embodiments, the three tanks shown in FIG. 6 can be part of one integrated tank multiple separated compartments, with an optional means for connecting the second and third tanks together. In this way the driver has the option of filling up with a larger amount of a fluid that can be directly used for direct injection knock control, by filling both tanks 103 and 102 with an appropriate knock avoidance fuel.

In another embodiment for the tank system, the second tank can be the same tank that contains the windshield cleaner. Windshield cleaner is typically a mixture of water and alcohol (such as methanol or ethanol). In this embodiment, the windshield cleaner can be used both for windshield cleaning and for providing the fluid for ethanol separation from gasoline.

As stated above, typical windshield cleaner is a methanol-water mixture. The methanol concentration may be in the 20-40% range. There are also some windshield cleaner fluids that use ethanol as the alcohol. Since methanol has a significantly higher vaporization cooling effect than ethanol, the difference in the knock suppression capability between water only injection and 100% alcohol injection would be less than the case of ethanol.

With regard to using the same fluid for both windshield cleaning and knock suppression, it may be desirable to modify the formulation of this fluid so that it is suitable for engine use while also meeting the less stringent requirements for windshield cleaner use. Either presently marketed windshield cleaner or a specially formulated fluid might be used for both knock suppression and windshield cleaning. The specially formulated fluid may eliminate one or more constituents that are present in presently marketed windshield cleaner in order to insure compatibility with engine operation requirements. Alternatively or additionally, the specially formulated fluid may include additional constituents that are not present in presently marketed windshield cleaner. For example, a lubricant to insure proper function of the fuel injectors might be added. Other variations include increasing the alcohol content or changing the type of alcohol that is used.

When the fluid is used for windshield cleaning, it can be directly transported to the windshield sprayers by a piping system that is separate from that which is used to transport it to the alcohol separation unit or to the fuel injectors.

In some embodiments, the filling of a tank that contains a liquid that can be used for knock suppression, alcohol separation and/or windshield cleaning can be carried out in a way that would virtually eliminate the spillage that occurs with the present addition of windshield cleaner. For example, the tank may be filled by use of a fill pipe that allows filling without opening the hood, similar to filling the gasoline tank through an inlet on the side of the vehicle. The fill pipe could accommodate a hose nozzle from a pump, the long snout from a container or it could have a retractable funnel for filling with a container. The tank may be located next to or could be a compartment in an integrated fuel tank that also includes the tank for the gasoline. Fluid for cleaning the windshield could be piped to a smaller tank that is located under the hood prior to being sprayed on the windshield. This smaller tank under the hood could be the same tank that is used in present vehicles to store windshield cleaner.

In another embodiment, the system controller is able to limit the amount of fluid used for windshield cleaning if the consumption rate becomes too great, such as due to driving under conditions that quickly create a dirty windshield. In this way, the amount of fluid available for knock suppression is not adversely affected by excessive windshield cleaning.

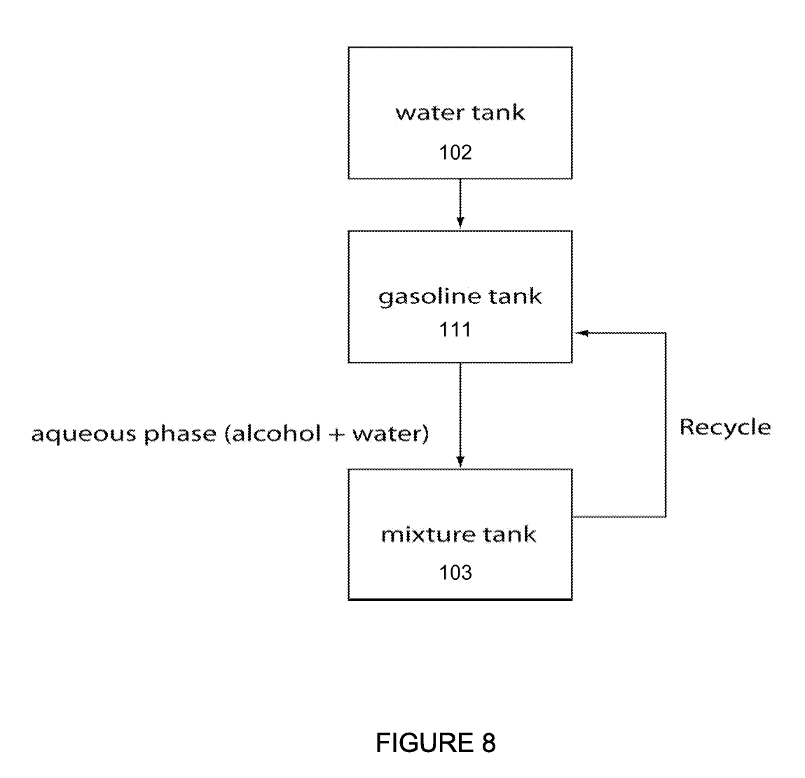

In another embodiment, the separation region can be combined with one of the tanks, such as the first or second tank. This alternative approach is shown in FIG. 8. FIG. 8 is similar to FIG. 6 with the difference that the discrete separation unit has been eliminated, and the separation region has been incorporated in the first tank 111. Separation and storage takes place directly in the gasoline tank 111. This gasoline tank 111 is more complex than a traditional storage tank, as it contains the devices need to achieve separation.

In one embodiment, there is direct contact between the aqueous and organic phases in the gasoline tank 111. In one embodiment, the ethanol is separated gravimetrically. In this case, the water may be introduced into the gasoline through a device that generates very small droplets of water, such as an atomizer. In this manner, because of the large surface area to volume ratio, the equilibrium between the aqueous and organic phases is achieved quickly. The separation is determined by the settling rate of the water droplets to a place where they can be collected. A sensor monitors the composition of the liquid that is being extracted, and ceases extraction when it is determined that the fluids has high hydrocarbon content.

In a further embodiment, a centrifugal separator can be used to increase the effective acceleration and speed up the settling of the droplets. The centrifugal separator may provide a spinning motion to the gas in the tank, or it can be a separate unit, as in separator unit 104.

In an alternative embodiment, small gasoline droplets can be introduced into an aqueous media in third tank 103. The hydrocarbon phase settles at the top of the tank, because of lower specific weight. The purpose, in either case, is to increase the surface area to achieve fast separation.

In another embodiment, the aqueous and organic phases are separated by the use of a membrane. The membrane may be a hydrophobic membrane, with aqueous phase on one side and gasoline-ethanol blends on the other. The aqueous phase provides a driving force across the membrane to extract the ethanol from the gasoline-ethanol blends.

As was described above, it may be desirable to recycle the secondary fluid from the mixture tank when conditions are such that the concentration of ethanol in the secondary fluid can be increased. This recycle path is shown in FIG. 8.

The sizes of the various tanks shown in FIGS. 6-8 can be adjusted, depending on the vehicle requirements. As described above, it is possible that a given amount of water removes three to four times its volume of ethanol.

Furthermore, the resulting relatively high ethanol concentration mixture is about 1.5-2 times as effective in preventing knock as neat ethanol or E85 (as shown in FIG. 4). Thus, a 2 gallon water tank (i.e. second tank 102) could produce the equivalent of 6-8 gallons of anti-knock fluid. With the increased knock resistance of the water-alcohol mixture, it may be possible to allow for long refilling times for the water tank 102. Of course, larger or smaller tanks could be used, with a correspond change in the amount of anti-knock fluid that can be created and stored.

Alternatively, if the externally supplied fluid is water (or water with an additive), it may be possible for the operator to refill the water tank, as is now done for windshield cleaner fluid. There may a need for a substantial size mixture tank (as shown in FIGS. 6 and 8). However, the refilling interval for water would be longer than that for ethanol or E85, if either of these were used as the anti-knock fluid alone. This is because an amount of water produces nearly four times that amount of anti-knock fluid, and that fluid is more effective at eliminating knocking then pure ethanol, as shown in FIG. 5.

Of course, it is possible to make an integrated tank unit that contains separate compartments that form the multiple tanks that are required in the process, either two tanks or three tanks, depending on the approach.

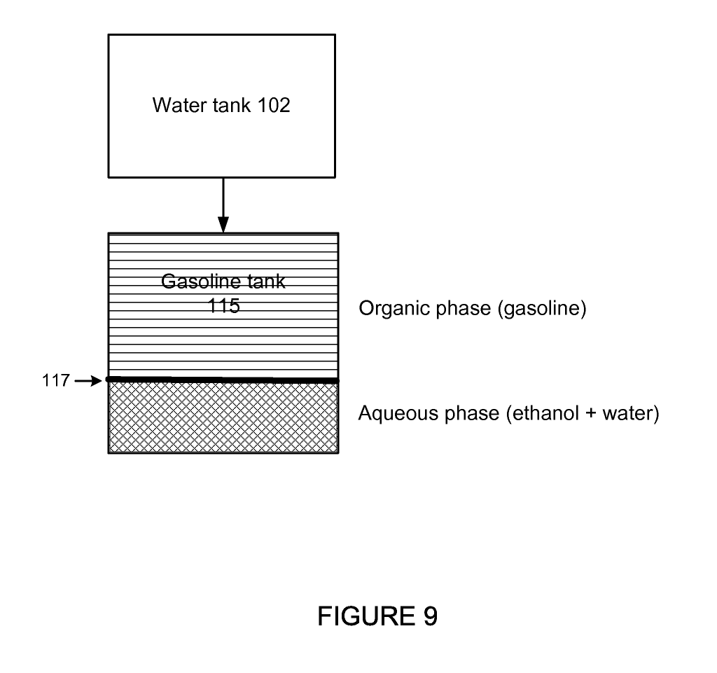

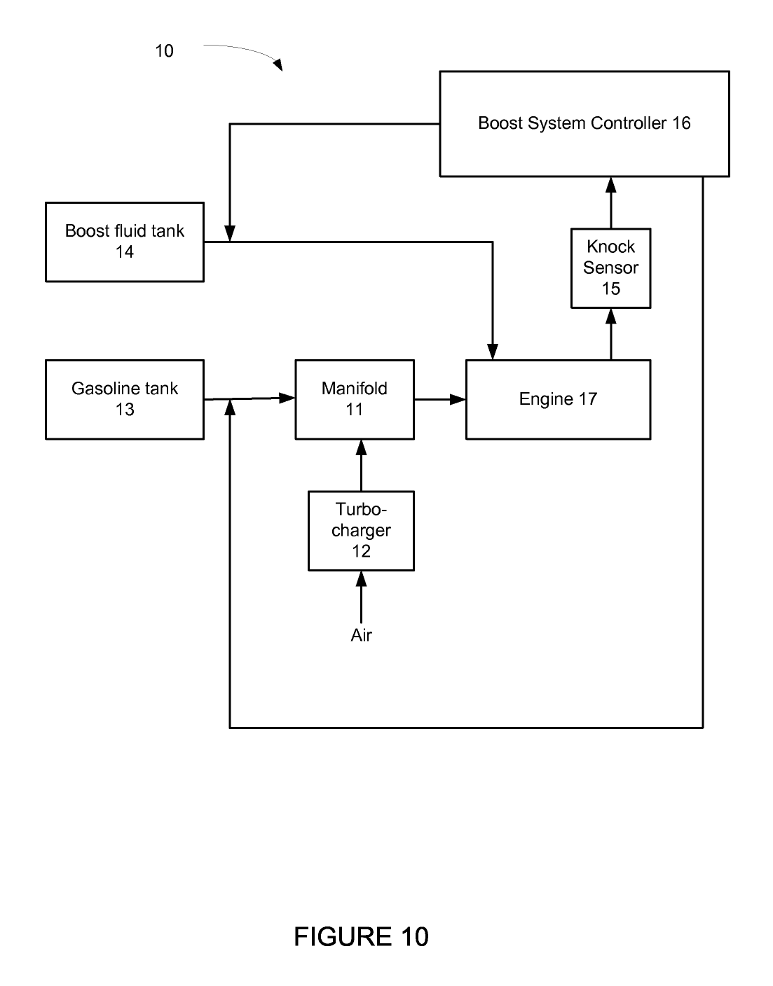

Another embodiment is shown in FIG. 9. In this case, the separate mixture tank is eliminated. The aqueous phase is stored in a volumetric space that exists within the gasoline tank 115. The aqueous phase and the organic phase share the same gasoline tank 115, with the heavier aqueous phase sinking to the bottom of the tank 115. The water tank 102 provides additional separating fluid (water or water-alcohol mixture) when it is needed to replenish the aqueous phase. The aqueous phase and the gasoline blend will be in continuous equilibrium, with the need to recycle the aqueous phase, as was mentioned in the systems shown in FIGS. 6 and 8. The fuel pumps need to selectively introduce organic phase (for the port fuel injection) and ethanol/water mixtures (for the direct injection). The inlet for the gasoline pump is adjusted in order to provide for changes in the amount of aqueous phase at the bottom of the tank. The buoyancy of the gasoline pump inlet can be adjusted, for example, so that it sits at the interface between the two phases, and sucks liquid from the lighter phase.

In some embodiments, a layer 117 is placed in between the two phases in order to prevent unnecessary mixing of the aqueous/organic phases. The layer 117 may be a hard material, or it could a fabric or layer. The layer could have buoyancy that would place it in the region between the aqueous and gasoline phases. It needs to provide for flow from one region to the other, such as through holes in the layer itself or in the boundary between the layer and the inner surface of the tank.

One advantage of this system is that when the water from the water tank and the aqueous phase in the primary gasoline tank are spent, the system can partially recover by injection of gasoline through the DI injector that is usually used for DI of the aqueous mixtures. This same objective can be achieved by valves between separate tanks 100 and 103.

In all embodiments, it may be beneficial to add an additive to the anti-knock fluid prior to its introduction to the engine. For example, in some embodiments, a lubricant is added so as to extend the life and improve the performance of the direct injectors. It is also likely that hydrocarbons from the gasoline will mix with the antiknock fuel and provide the required lubricity.

After prolonged operation without refueling of the second tank 102, it is possible to reach a condition where there is no available anti-knock fluid. In the embodiments shown in FIG. 6-8, this occurs when both the second tank 102 and the mixture tank 103 have been depleted. In the case shown in FIG. 9, this occurs when water tank 102 is depleted and no aqueous phase exists in gasoline tank 115. In this situation, special management is needed in order to modify the driving conditions such that the inconvenience to the driver is minimized.

When both the second tank 102 and third tank 103 have been depleted, and water is added to the second tank 102, it will take some time to build up the volume of fluid in the third tank 103, as even removing all of the alcohol from the gasoline will not suffice to fill the mixture tank 103 with fluid having an optimal concentration of ethanol. That is, the most ethanol that can be retrieved from a 20 gallon tank filled with E10 is 2 gallons, which is not enough to fill the mixture tank 103 with a second fluid that has high concentration of ethanol, assuming the size of the mixture tank 103 is greater than 3 gallons in capacity.

Under this set of circumstances, as separating fluid is added, it separates some of the ethanol from the gasoline, although in a concentration lower than the optimal amount. Therefore, it is likely that the alcohol concentration in the fluid contained in the mixture tank 103 (the third tank) will be low, or the total amount of liquid in that tank will be low. In this embodiment, it may be necessary to introduce additional separating fluid directly to the mixture tank to make up for the lack of ethanol mixture. A path from the second tank 102 to the mixture tank 103 is shown in FIG. 6. As the gasoline in the primary tank 100 is used and the tank is refilled, it is now possible to increase the concentration of ethanol in the third tank 103. As described above, the aqueous solution in the third tank 103 can be recycled through the separation unit 104 or separation region. As long as the ethanol concentration in the aqueous solution is lower than the equilibrium concentration of ethanol in the aqueous solution, the concentration in the aqueous solution will increase. The process can be repeated until the concentration of the solution in the third tank 103 is equal to the equilibrium concentration.

In another embodiment, separating fluid is added directly from the second tank 102 to the third tank 103 in quantities such that the ethanol concentration in the aqueous solution is not less than a predetermined threshold. The predetermined threshold may be set so as to minimize misfire, which is associated with large amounts of water being added to the cylinder to prevent knock. However, at conditions when the direct injection of the antiknock agent is likely to be needed, that is, at high torque and lower speeds, the issue of misfire is not as serious as under conditions of low torque. Thus, the threshold value used may be modified by the system controller. This modification may be based on the driving conditions experienced over the previous time period. In other words, if the vehicle has operated continuously under a high torque condition (such as prolonged towing), the threshold value may be different than if the vehicle has been subject to highway driving. This determination can be made by monitoring the vehicle drive cycle over an extended period. In one embodiment, the system controller monitors the vehicle drive cycle by recording torque and RPM over an extended, or rolling, time period and interpolating future drive patterns based thereon.

In another embodiment of the invention, the fluid from the second tank 102 and the fluid from the third tank 103 are both injected directly into the engine. This makes it possible to optimize both the use of the water in the second tank 102 and the separated fluid in the third tank 103. The required mix of fluids from the second and third tanks may be determined by the system controller 105. The system controller 105 may utilize inputs from the engine to determine the proper mix. In some embodiments, a signal from a knock detector and a signal from a misfire sensor that determines combustion stability are used. In one embodiment, the fluids are sent to the direct injector by separate fuel lines. In another embodiment, the fluid from the second tank 102 is directed to the third tank 103. In another embodiment, the two fluids are sent to a mixing chamber prior to direct injection into the engine.

In one embodiment, the system controller 105 uses the knock sensor to determine the amount of separating fluid (water or water-alcohol mixture) to introduce to the cylinder. If the misfire sensor notifies the controller of the occurrence of misfire, the controller can either add additional fluid from the second tank, or disable the separating fluid and utilize only the anti-knock fluid.

Direct use of the fluid from the second tank 102 for knock control generally results in a higher consumption rate than when it used for separation of alcohol from the alcohol-gasoline mixture. Despite this, its direct use can insure that there will be anti-knock fluid available, particularly at those times when the alcohol from the gasoline-alcohol mixture is not available such as when it has been substantially depleted from the gasoline-alcohol mixture. The system controller 105 can be used to vary the contributions of direct anti-knock use of the fluid from the second tank 102 and use of the fluid from the third tank 103, based on variety parameters described above.

A situation where the fluid from the third tank may not be sufficient occurs during conditions when the torque is consistently high, as during prolonged towing. Under this condition, the fluid in the third tank can be rapidly depleted due to depletion of the alcohol in the gasoline-alcohol mixture. The addition of water to either the second tank 102 or directly to the cylinder can be used to augment the amount of antiknock fluid available to the engine.

As with the case of neat ethanol or high concentration of ethanol (as in E85), techniques such as spark retard, or higher speed engine operation for the same power (up-speeding) can be used to minimize the amount of antiknock agent needed during conditions of prolonged towing. Decreasing the maximum torque available may also be used in order to protect the engine from damage.

In order to minimize emissions, the same fuel canister that contains the evaporative emissions from the main fuel tank can be used to control the evaporative emissions from the alcohol-water mixtures. The canister can be regenerated during normal engine operation.

Alternatively, a separate canister can be used for controlling the emissions from the tank that contains the water-alcohol mixtures. This canister can also be regenerated during the normal engine operation.

In either case, the size of the canister has to be sized appropriately. It should be pointed out that conventional windshield-washer fluid container (which could have comparable composition to the antiknock fuel) presently has no evaporative emission control.

Another embodiment of the present invention is the use of a water-based fluid (such as water or a water-alcohol mixture) supplied by a source outside of the vehicle (e.g by a pump or a container) as a means to prevent knock. As described above, the water or water-alcohol mixture can be directly injected into the cylinder, in such a way so as to prevent misfire. In some embodiments, a misfire detector is used to detect misfire and thereby limit the amount of water-based fluid that is introduced into the engine as more is called for to prevent knock. In one embodiment, when the amount of water or the water-alcohol mixture that is needed to prevent knock is greater than the amount that causes combustion instability and misfire, increased spark retard can be employed to prevent knock. Alternatively, the manifold pressure (and thus the maximum torque) can be limited, for example by waste gate operation in a turbocharged vehicle.

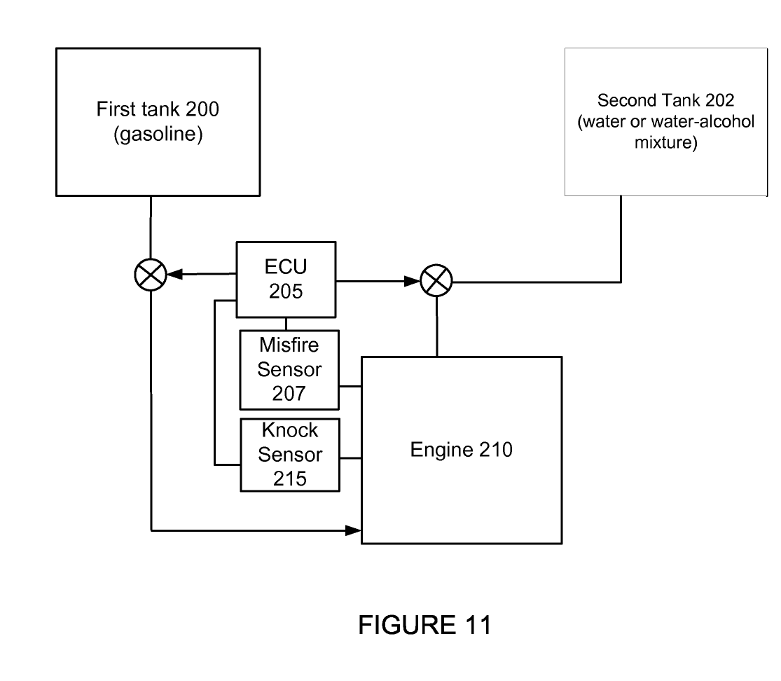

In some embodiments, a closed loop system, containing a system controller or ECU 205, a misfire sensor 207 and a knock sensor 215 is used to control misfire, as shown in FIG. 11. The second tank 202 may be the mixture tank 103 of FIG. 6, or a tank that is filled by externally supplies fluid. As described above, misfire can be controlled by reducing introduction of antiknock fluid through operation in a manner to reduce the engine tendency to knock, such as through spark retardation or manifold pressure reduction. In FIG. 11, the system controller 205 is in communication with misfire sensor 207, which detects when the water/fuel ratio is too great. The system controller 205 is also in communication with a knock sensor 215, which determines the need for anti-knock fluid. Based on these two inputs, the system controller (ECU) 205 controls the quantity of gasoline and anti-knock fluid supplied to the engine 210. In some embodiments, the ECU 205 is also able to control additional features, such as spark retard, or turbocharged manifold pressure values. In some embodiments, only one of the two sensors shown is used.

In another embodiment, open loop control logic using engine maps can be employed to insure that the amount of water used does not cause misfire. This open loop control can be used to limit the anti-knock fluid/gasoline ratio. In some embodiment, the open loop control can be used in conjunction with or in place of closed loop control from a misfire detector 207.

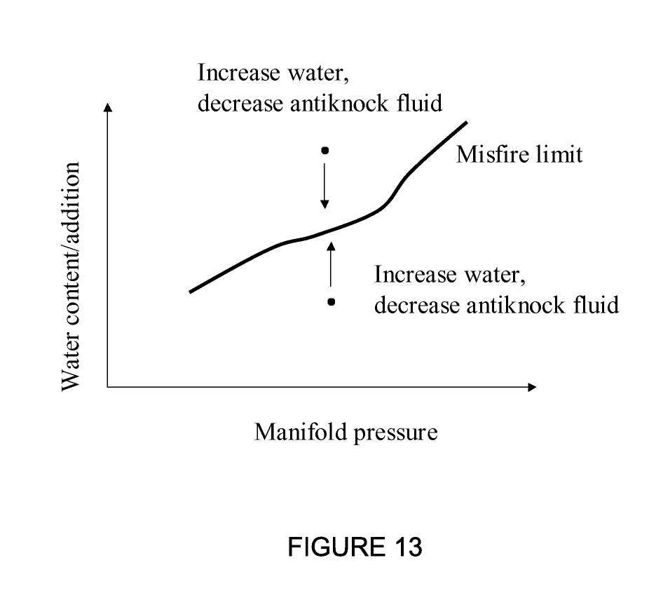

For example, it is possible to construct a curve which illustrates the anti-knock fluid/fuel ratio at which knocking occurs, as a function of operating parameters, such as manifold pressure, torque and engine speed. Similarly, it is possible to construct a curve which illustrates the anti-knock fluid/fuel ratio at which misfire occurs, also as a function of operating parameters, such as manifold pressure, torque and engine speed. A simplified version of such a graph is shown in FIG. 13. In FIG. 13, the misfire limit is shown. Water addition is similar to the use of EGR, and the impact of EGR on misfire is well known, increased EGR increases misfire, and the limit increases with increasing pressure, as illustrated in FIG. 13. In operation below the misfire limit, the control system may choose to increase water and decrease antiknock fluid from tank 103. If misfire is likely, the controller can decrease water and increase the use of the antiknock fluid. Using these graphs, the system controller 205 can monitor engine operating parameters and the water/fuel ratio, and determine when adjustments are required. In other words, rather than directly measuring knock, the system controller 205 can anticipate knock based on other known parameters and the relevant graph.

An open loop system has some drawbacks. For example, without knowledge of the gasoline and anti-knock fluid characteristics and air humidity, it cannot accurately predict knock and misfire. For example, an open loop system may not be able to factor in the effects of the fuel's octane rating (as it may be unknown to the controller). Further, the alcohol concentration of the anti-knock fluid also affects the knock and misfire behavior of the engine. Thus, in some embodiments, a knock detector 215 can be employed to control the amount of water or water-alcohol mixture from the second source that is used to prevent knock as the torque is increased or as the octane rating of the fuel from the first tank changes.

As the torque increases at a given RPM, the ratio of anti-knock fluid to gasoline that is needed to suppress knock increases. If this ratio is too high, misfire could occur. As described above, when the misfire detector 207 senses the occurrence of misfire, a closed loop control system will limit the anti-knock agent/gasoline ratio so as to prevent misfire.

When the misfire detector 207 senses that misfiring has occurred, the system controller or ECU 205 acts to limit the knock, which in turn reduces the need for the water or water-alcohol mixture. The system controller 205 may limit torque and/or increase the spark retard to achieve this goal.

As shown in FIG. 13, the anti-knock fluid/gasoline ratio at which misfire could occur increases with changes in engine operating parameters, such as increasing manifold pressure. Depending on the shape of the anti-knock fluid/gasoline ratio vs. torque curve for knock suppression and the anti-knock fluid/gasoline ratio vs. torque curve for misfire, a situation may arise where there is a torque range where misfire could occur at the anti-knock fluid/gasoline ratios needed to prevent knock followed by a higher torque range where misfire will not occur. In this case, increased spark retard would be used in this misfire range. Alternatively, the addition of alcohol from a third tank could be employed.

High compression ratio operation (operation with a compression ratio of 12 or higher) can be used to allow larger amounts of water injection without misfire, as it is well known that misfire is less likely at high torque conditions. An enhanced higher energy ignition system that enables faster and more stable combustion can also be employed.

Because of the great effectiveness of directly injected water in suppressing knock, the volume ratio of required anti-knock fluid to gasoline is kept at a modest level (e.g., less than 1.5 and preferably less than 1), even when used to prevent knock at compression ratios greater than 10 and manifold pressures greater than 2 bar. This allows the use of water-alcohol mixtures with substantial water fractions without creating misfire.

The relative amount of water required for controlling knock is small. For low engine speeds and high boosting, the water consumption rate by volume is about half that of gasoline. As the amount of air required for stoichiometric operation is about 15 times the mass of gasoline, the amount of water required at the worst conditions is about 1/30^{th} the mass of air (i.e., 3% by mass, or 5% by moles). For this small fraction of water or water-alcohol mixture that is injected, the impact of the small fraction of water or water-alcohol injected on misfire is mainly due to the large evaporative cooling effect needed for controlling knock, and not the dilution of the air/fuel mixture.

In another embodiment, the use of a stratified water or alcohol-water mixture in the cylinder can be employed. Stratified conditions can be achieved with either late injection of the antiknock agent, or organized motion in cylinder that maintains stratification, such as swirl motion, which keeps colder regions, less likely to knock, in the periphery that contains most of the unburnt fuel. If the water-based anti-knock fluid is injected so as to be located away from the spark, the local temperature near the spark can be higher than the temperature in the regions of the unburnt air/fuel fraction that are prone to ignite. The kernel formation (required for good ignition), flame development and flame speed are therefore not affected in the region close to the spark, and thus misfire can be reduced or prevented. Misfire can be determined by the Coefficient Of Variation (COV) of Indicated Mean Effective Pressure (IMEP). It can be related to variations of the 0-10% combustion of the air fuel mixture. By keeping the temperature hot and the dilution to a minimum in the region of the spark, robust ignition can be achieved. In addition, a high-energy ignition system can be used to avoid misfire. The high-energy ignition system can use multiple spark plugs.

In addition, the use of stratified water based anti-knock fluid alleviates the problem of preignition that could occur in engines that operate with high concentrations of ethanol fuels.

Table 1 shows examples of temperatures and pressure resulting for the use of various anti-knock fluids to provide knock suppression at high torque.

TABLE 1
Examples of temperatures and pressures, for engine operation at low
engine speed and 2 bar manifold pressure for different anti-knock
fluids (ethanol, water, and water/ethanol mixes)
1000 rpm
Manifold pressure (bar) 2

| | | 50% water | 25% water | |
|---|---|---|---|---|
| | Water | in ethanol, | in ethanol, | Ethanol |
| | only | by weight | by weight | only |
| Cylinder pressure, | 1.41 | 1.51 | 1.54 | 1.63 |
| after cooling (bar) | | | | |
| Final temperature | 296.9 | 319 | 325.4 | 344 |
| after cooling (K) | | | | |
| Antiknock agent as | 0.61 | 1.3 | 1.73 | 2.4 |
| fraction of gasoline | | | | |
| (by mass) | | | | |

Table 1 shows that as the water content in the anti-knock fluid increases, both the cylinder pressure and final temperature after cooling decrease. The illustrative parameters in Table 1 are given for initial cylinder pressures and temperatures after evaporation of the anti-knock fluid, as well as the amount of the anti-knock fluid required, for controlling knock. It is assumed that evaporation is instantaneous and occurs right after Inlet Valve Closing. Although much less water is required, the effect on the temperature is very pronounced. Water has a volumetric cooling effect (heat of vaporization times specific weight) that is about 3.5 times that of ethanol. The final temperature in the case of water-only injection (leftmost column) is near room temperature. It is thus possible that not all the water can be evaporated early in the compression stroke, due to the finite vapor pressure of water at this temperature and the short times involved. However, later in the cycle the temperatures will be high enough to evaporate the water.

In one embodiment, late injection of the water can be used to minimize this condition, or long duration (where some of the water and/or alcohol anti-knock agent is injected prior to inlet valve closing and some after inlet valve closing). Although the effect of charge cooling is less pronounced when the evaporation of the anti-knock fluid occurs prior to the inlet valve closing, it can be compensated for with increased use of the anti-knock fluid.

It is preferable that water-based anti-knock fluid injection be used with warmed-up engine conditions, thereby minimizing the possibility of wall wetting and borewash or oil dilution. In some embodiments, the fuel management system of FIG. 11 controls whether water-based anti-knock fluid is used under conditions that can result in oil dilution and/or borewash. This can be done by preventing the engine from operating at the highest torques, while cold. A closed loop system, as well as open loop system, can be used to control the water-based antiknock fluid injection during cold-engine conditions. In some embodiments, the controller 205 requires that the engine 210 operate mainly on gasoline with no or very limited anti-knock agent until the engine is heated. In these embodiments, a temperature sensor, which measures the temperature of the engine 210, can be employed to allow the controller 205 to determine the proper operating mode.

The fuel control system determines the timing and the duration of the water or water/alcohol injection. Early injection can result in evaporation cooling prior to inlet valve closing, and thus additional air is trapped into the cylinder. Early injection also allows for longer evaporation times, as in some cases the final temperatures are low.

In order to minimize the rate of consumption of water or water-alcohol mixture from the second source when prolonged high torque operation is employed in the operation of a vehicle, additional increases in spark retard can be employed with the consequence that efficiency can be significantly decreased. Engine up-speeding (change of gearing so as to operate at higher rpm for the same power) can also be employed.

An advantage of water or water/alcohol injection over pure alcohol injection for knock control is that substantially less fluid is required, simplifying the design and operation of the injector. It is desirable to have a wide dynamic range of the injector, from no injection (when the anti-knock fluid is not required) to substantial injection (such as about half the amount of the gasoline for the highest condition illustrated above, although higher quantities are within the scope of the invention). The rate at which the anti-knock fluid is injected is determined based on the maximum amount that must be accommodated. This rate is given by the maximum amount divided by the time during which the injector can be open. Given this flow rate, there is also a minimum amount that can be injected (if any fluid is injected), as there is a constraint on the minimum opening time of the valve in the injector. Thus, a reduction of the maximum amount that needs to be injected allows for reduction of the minimum amount of the fluid that can be injected, thereby reducing the overall consumption of the antiknock agent.

Although use of water only has the theoretical advantage of minimizing the amount of anti-knock fluid required for knock control, various factors (including misfire and the need for a certain level of alcohol to prevent freezing), may suggest an optimum water fraction that is between water only and alcohol only.

The control system described above can be employed for gasoline-alcohol mixtures in the first tank. If the water-alcohol mixture is externally supplied, or water is used as the anti-knock fluid, the fuel in the first tank need not contain alcohol.

In addition, the externally supplied anti-knock fluid may be windshield cleaner, as described above.

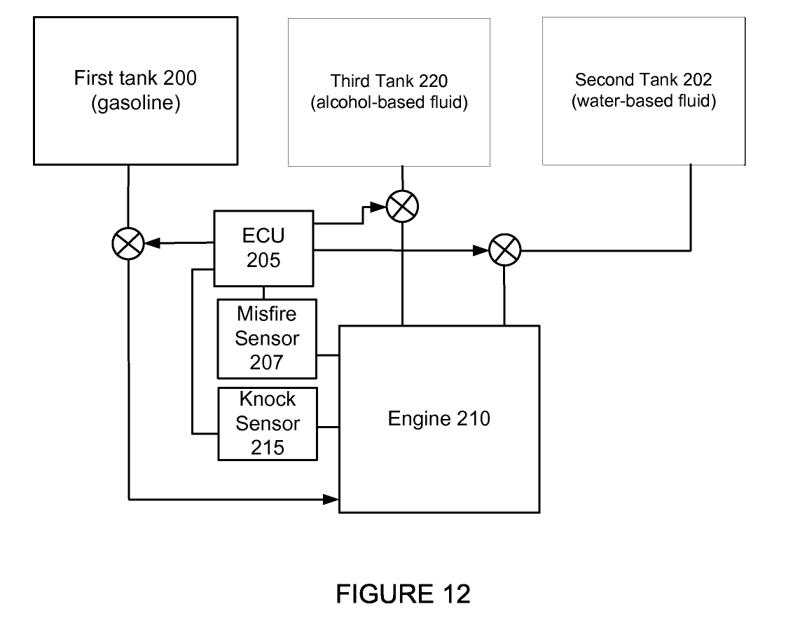

In another embodiment, a third tank 220 that contains an alcohol-based fluid, having a higher concentration of alcohol than the water-based fluid in the second tank 202, is employed in addition to the second tank 202 that contains the water-based fluid. In this embodiment, which is shown in FIG. 12, the fluid from this third tank 220 would be employed when misfire limits use of the water-alcohol or water fluid from the second tank 202. The rate of consumption of the fluid in the third tank 220 would be very low since it would only be used at the very highest levels of torque or when the engine tends to misfire because of introduction of water from the second tank 202.

In some embodiments, the system controller 205 uses closed loop control, employing a misfire sensor 207 and a knock sensor 215 to determine the amount of water-based fluid and alcohol-based fluid that should be injected. In some embodiments, the system controller 205 uses the knock sensor to determine the appropriate amount of water-based fluid to use. If this amount causes misfire, as detected by the misfire sensor 207, the system controller 205 can switch to the alcohol-based fluid.

In other embodiments, the system controller may use open loop control, relying on engine maps to determine when misfire has occurred and using a knock sensor to determine the appropriate amount of fluid to be injected. In other embodiments, the system controller may use open loop control, relying on engine maps to determine the appropriate amount of fluid to be injected and using a knock sensor to determine when misfire has occurred. In other embodiments, the system controller performs all functions using open loop control.

In an embodiment, the windshield cleaner tank may be employed as either the second tank 202 or third tank 220. In the case where the windshield fluid has a high concentration of alcohol, it may be employed as the third tank, while the second tank is used to hold water.

The direct water injection technologies that are described above can also be employed in spark ignition engines that operate with fuels other than gasoline, such as LPG, CNG, LNG, ethanol (e.g. E85, E100), methanol (e.g. M85, M100), isobutanol and others. Both vehicular and stationary engines using natural gas and other gaseous fuels could employ these technologies.

A wide range of water and mixtures of water with an alcohol could be used as the refill liquid to the second tank. In the case of multiple alcohols, it would be necessary to determine the concentration of each one of the alcohols, rather than the total amount of alcohol. The concentration of alcohols can be determined by any of a number of means, including but not limited to, dielectric constant and spectroscopic measurements.

When the externally added fluid is a water/alcohol mixture, it would be possible to combine the container for the windshield-washer fluid with the second tank that holds the externally added substance and to vary the water/alcohol mix in the second tank as needed to prevent freezing. Indeed it would be possible to subdivide this tank into two compartments, one containing high concentration of the ethanol or methanol and the second one for introduction of just water. To prevent problems with freezing, the alcohol from alcohol-container is introduced into the container for the water, to concentrations that will prevent freeze-up of the water. The amount of alcohol that is added to the water can be varied according to a measurement of temperature. The alcohol container needs to be filled up periodically, but because it is now just an anti-freezing additive, it is needed at much reduced rates.

In another embodiment, a small separate tank is used which adds a lubricant or other additive to the anti-knock fluid before it enters the fuel injector. This embodiment can allow the filling of the second tank with windshield cleaner or other anti-knock fluid, which would otherwise not meet the requirements for engine operation.

A further embodiment involves the use of a sensor to insure that the anti-knock fluid has the necessary properties before it is allowed to flow into the fuel injectors. The sensor determines if the anti-knock fluid has the proper characteristics and provides information to a system controller, which does not allow use of the anti-knock fluid in the fuel injectors if it does not have the proper characteristics. Such characteristics include but are not limited to alcohol/water composition, absence of lubricity agent, contamination.

Although direct injection of the anti-knock fluid is described, it is also possible to use port injection of the anti-knock fluid through an injector that is separate from a port injector that injects the fuel from the first source. However, port injection of the anti-knock fluid would require greater amounts of anti-knock fluid to suppress knock. In this case, misfire may be a much more constraining limit on the percentage of water used in the alcohol -water mixture. The fuel from the first source can be injected either by port injection or by direct injection.

In another embodiment, the amount of water-alcohol direct injection is greater than that needed to prevent knock.

Although the embodiments in this disclosure are described for water-alcohol mixtures, it is intended that they include any water-organic compound. Furthermore, although many embodiments utilize ethanol, the alcohol in the water-alcohol mix can include, but is not limited to ethanol, methanol and isopropyl alcohol.

What is claimed is:

1. A fuel management system for separating alcohol from a gasoline-alcohol blend that is stored in a first tank, comprising:
a second tank containing a separating fluid;
a separation region into which said separating fluid and said gasoline-alcohol blend are passed, and which produces a second fluid containing alcohol from said gasoline-alcohol blend and returns gasoline with diminished alcohol content to said first tank; and
a volumetric space in which said second fluid is stored.

2. The fuel management system of claim 1 where said second fluid is directly injected into a cylinder of a spark ignition engine.

3. The fuel management system of claim 1 or 2, wherein said alcohol in said gasoline-alcohol blend is selected from the group consisting of ethanol and methanol.

4. The fuel management system of claim 1 or 2 wherein said separating fluid is selected from the group consisting of water, a water-alcohol mixture and windshield cleaner.

5. The fuel management system of claim 4 wherein said alcohol in said water-alcohol mixture is selected from the group consisting of ethanol, methanol and isopropyl alcohol.

6. The fuel management system of claim 1 wherein separating fluid comprises windshield cleaner, and said fuel management system is located within a vehicle having a windshield, and second tank comprises the source of cleaner for said windshield.

7. The fuel management system of claim 1, wherein said separation region comprises membranes.

8. The fuel management system of claim 1, wherein said separation region utilizes physical separation.

9. The fuel management system of claim 8, wherein said physical separation is selected from the group consisting of gravity and centrifugal separation.

10. The fuel management system of claim 1, wherein said separation region utilizes chemical separation.

11. The fuel management system of claim 1, comprising a controller configured to determine when said separation is performed.

12. The fuel management system of claim 11, wherein said controller carries out said separation at low temperatures to increase the effectiveness of said separation.

13. The fuel management system of claim 12, further comprising a temperature sensor.

14. The fuel management system of claim 1, further comprising a path between said second tank and said volumetric space such that said separating fluid can be transferred directly to said volumetric space.

15. The fuel management system of claim 14, wherein the amount of separating fluid transferred directly to said volumetric space is varied so as to match the requirements of different engine operating conditions.

16. The fuel management system of claim 2, wherein said separating fluid is directly injected into a cylinder of a spark ignition engine.

17. The fuel management system of claim 16, comprising a misfire sensor and a controller, wherein said controller controls the amount of said separating fluid that is injected into said cylinder, based on feedback from said misfire sensor.

18. The fuel management system of claim 16, comprising a controller, wherein said controller varies the ratio of said separating fluid to said second fluid being injected into said cylinder, based on predetermined criteria.

19. The fuel management system of claim 18, wherein said predetermined criteria is selected from the group consisting of engine torque, engine speed, misfire, knock, the amount of alcohol already separated from said gasoline, the volume of said second fluid in said volumetric space, and the volume of said separating fluid in said second tank.

20. The fuel management system of claim 1, further comprising a path between said volumetric space and said separation region, so that said second fluid may be used in said separation process.

21. The fuel management system of claim 20, further comprising a controller, wherein said controller determines whether said separating fluid or said second fluid is supplied to said separation region, based on predetermined criteria.

22. The fuel management system of claim 21, wherein said criteria is selected from the group consisting of the desired alcohol concentration in said second fluid, the ambient temperature, the temperature difference since a previous separation process, the amount of said separating fluid, and the amount of said second fluid.

23. The fuel management system of claim 1, wherein said volumetric space comprises a third tank.

24. The fuel management system of claim 1, wherein said volumetric space is located within said first tank, and are kept separate by gravimetric means.

25. A fuel management system for a spark ignition engine having at least one cylinder, wherein a fuel is introduced into said engine cylinder and an amount of a water-based fluid is directly injected into said engine cylinder, comprising a controller adapted to determine said amount of water-based fluid, such that said amount of directly injected water-based fluid is no less than the quantity needed to prevent knock and is less than the quantity which causes misfire.

26. The fuel management system of claim 25 wherein the ratio of said water-based fluid to said fuel varies with torque.

27. The fuel management system of claim 25, wherein said fuel is selected from the group consisting of gasoline, ethanol and natural gas.

28. The fuel management system of claim 25 wherein said water-based fluid contains alcohol.

29. The fuel management system of claim 28, wherein said water-based fluid is between 20% and 70% alcohol.

30. The fuel management system of claim 25, further comprising a misfire sensor and a knock sensor and wherein said controller determines said amount based on feedback from said misfire and said knock sensors.

31. The fuel management system of claim 25, wherein said controller alters the engine operation if the quantity of said directly injected water-based fluid required to prevent knocking is greater that the quantity that causes misfire.

32. The fuel management system of claim 31, wherein said controller alters said engine operation by implementing spark retard.

33. The fuel management system of claim 31, comprising a compressor to compress air entering said engine and wherein said controller alters said engine operation by changing the manifold pressure of said air.

34. The fuel management system of claim 31, wherein said controller alters said engine operation by implementing upspeeding.

35. The fuel management system of claim 25, wherein said fuel management system is located within a vehicle having a windshield and said water-based fluid is also used as a cleaner for said windshield.

36. A fuel management system for a spark ignition engine having at least one cylinder, wherein a fuel is introduced into said cylinder and an amount of a water-based fluid is directly injected into said engine cylinder so as to prevent knock, comprising:
a sensor adapted to test said water-based fluid to determine if it has necessary characteristics for use with said engine, and
a controller, wherein said controller injects said water-based fluid into said engine based on said determination.

37. The fuel management system of claim 36, wherein said water-based fluid is also used as a windshield cleaning fluid.

38. A fuel management system for a spark ignition engine having at least one cylinder, wherein a fuel is introduced into said cylinder and an amount of a water-based fluid is directly injected into said engine cylinder so as to prevent knock, comprising a first source to hold said water-based fluid and a second source to hold a second fluid, wherein said second fluid is injected into said cylinder.

39. The fuel management system of claim 38, wherein said second fluid is added to said water-based fluid prior to direct injection of said water-based fluid.

40. The fuel management system of claim 38, wherein said second fluid comprises a lubricant.

41. The fuel management system of claim 38, wherein said second fluid comprises an alcohol.

42. The fuel management system of claim 38, comprising a path wherein said second fluid can be transferred to said first source.

43. The fuel management system of claim 38, comprising a path wherein said second fluid from said second source can be introduced to said engine cylinder.

44. The fuel management system of claim 38, further comprising a controller, wherein said controller determines the amount of said water-based fluid and said second fluid to introduce into said engine.

45. The fuel management system of claim 38, wherein said water-based fluid is injected into said cylinder based on a first set of operating conditions, and said second fluid is injected into said cylinder based on a second set of operating conditions.
